(19) United States
(12) Patent Application Publication
(10) Pub. No.: US 2024/0054556 A1
(43) Pub. Date: Feb. 15, 2024

(54) ONLINE COMMERCE PLATFORM

(71) Applicant: Motologiq, Inc., Horsham, PA (US)

(72) Inventor: George R. Lekas, JR., Horsham, PA (US)

(21) Appl. No.: 17/886,094

(22) Filed: Aug. 11, 2022

(51) Int. Cl. G06Q 30/08; G06Q 30/02

(52) U.S. Cl. CPC G06Q 30/08; G06Q 30/0206

(57) ABSTRACT

Some embodiments provide online commerce platforms with improved listing creation and bidding processes. In one embodiment, a method includes receiving, at a computing system from a device of a seller, data related to an item for sale and determining an estimated auction price for the item and a dealer price. The method then provides receiving a starting price and if the starting price is not less than the dealer price, prompting the seller to enter a starting price that is less than the dealer price. Additionally, the method provides receiving a reserve price and if the reserve price is not less than the estimated auction price, prompting the seller to enter a reserve price that is less than the estimated auction price. The method further provides establishing a listing for the item on the online commerce platform associated with the starting price and the reserve price.

### FIELD OF THE INVENTION

The present disclosure relates generally to online commerce platforms, and more particularly to methods, programs, and systems for an online auction platform with improved listing creation and bidding processes.

### BACKGROUND

An auction is a sale, usually open to the public, in which goods, services, or real property are sold to the highest bidder. The auction process includes offering a good, service, or real property for bidding, taking bids, and then selling the good, service, or real property to the highest bidder. Online auctions platforms like eBay have gained popularity for the buying and selling of almost all categories of products. Other online auction platforms have gained popularity specifically for the buying and selling vehicles. These online auction platforms, especially the ones for buying and selling vehicles, suffer from low quality listings and listings that do not result in sales.

More particularly, vehicle sellers often do not price their vehicle appropriately because of an inflated sense of their vehicle's worth and a lack of pricing information. Specifically, sellers will often overprice their starting price and reserve price compared to what the average, informed buyer would pay. This mispricing often leads to fewer overall bids and lower closing rates, and a poor user experience for both the buyer and seller.

Embodiments of the present disclosure envisions an improved online commerce platform that solves these problems.

### BRIEF DESCRIPTION OF THE DRAWINGS

FIG. 1 illustrates a conceptual overview of different stages of the online commerce platform according to some embodiments.

FIG. 2 shows an exemplary online commerce platform performing exemplary listing creation and bidding processes, according to some embodiments.

FIG. 3 shows a graph with the reserve price and starting price and their relationship with the estimated auction price and dealer price, according to some embodiments.

FIG. 4 shows an exemplary bidding process involving the proxy bid handler according to some embodiments.

FIG. 5 shows an exemplary bidding process according to some embodiments.

FIG. 6 shows another exemplary bidding process according to some embodiments.

FIG. 7A shows a flow chart of an exemplary listing creation process, according to some embodiments.

FIG. 7B shows a flow chart of an exemplary bidding process, according to some embodiments.

FIG. 8 shows a seller interface for inputting vehicle parameters of the online commerce platform according to some embodiments.

FIG. 9 shows the seller interface for inputting additional vehicle parameters, according to some embodiments.

FIG. 10 shows the seller interface for inputting additional vehicle parameters, according to some embodiments.

FIG. 11 shows the online commerce platform displaying the dealer price and the estimated auction price for an example car, according to some embodiments.

FIG. 12 shows a user inputting a starting price and a reserve price for a vehicle, according to some embodiments.

FIG. 13 shows the online commerce platform prompting the user to enter a starting price that is lower than the dealer price, according to some embodiments.

FIG. 14 shows the online commerce platform prompting the user to enter a reserve price that is greater than the dealer price, according to some embodiments.

FIG. 15 shows the online commerce platform prompting the user to enter a reserve price that is less than estimated auction price, according to some embodiments.

FIG. 16 shows the online commerce platform prompting a buyer to enter an updated bid in response to being outbid by the proxy bid handler, according to some embodiments.

FIG. 17 shows an overall flow of a method performed by the online commerce platform, according to some embodiments.

### SUMMARY

Some embodiments provide a method performed by an online commerce platform that improves listing quality and the likelihood of listing closing. The method includes receiving, at a computing system for an online commerce platform from a device of a seller, data related to an item for sale. The method also includes determining, by the computing system, an estimated auction price for the item and a dealer price, the estimated auction price being greater than the dealer price. The method then receives, at the computing system from the device of the seller, a starting price and if the starting price is not less than the dealer price, prompting the seller to enter a starting price that is less than the dealer price. Next, the method receives, at the computing system from the device of the seller, a reserve price and if the reserve price is not less than the estimated auction price, prompting the seller to enter a reserve price that is less than the estimated auction price. Further, the method establishes, by the computing system, a listing for the item on the online commerce platform, the listing associated with the starting price and the reserve price.

The following detailed description and accompanying drawings provide a better understanding of the nature and advantages of various embodiments of the present disclosure.

### DETAILED DESCRIPTION

In the following description, for purposes of explanation, numerous examples and specific details are set forth in order to provide a thorough understanding of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

Conventional online auction platforms have a problem with not being able to sell vehicles effectively. Vehicles listed on these platforms often do not perform as well and do not result in sales because sellers and buyers have different interests and asymmetrical information. One the one hand, the buyer may not have pricing information to price their car fairly. They may also have an inflated sense of their vehicle's worth or may feel that their vehicle ought to be priced higher than the fair market value. On the other hand, buyers tend to have more information through their due diligence. This leads to poor quality listings with high starting and reserve prices that can go for years without any bids. Online commerce platforms that have collected many of these poor-quality listings end up with unhappy buyers and sellers. Buyers have a bad user experience because of the poor-quality listings and sellers have a bad user experience because they can't sell their vehicles.

Moreover, traditional online auction platforms have a problem with the bidding process. For the bidding process to be successful, at least two interested bidders should participate in the bidding. Otherwise, the listing stays at the current price and never exceeds the reserve price needed to create a transaction between the buyer and the seller. Many listings in traditional online commerce platforms, if they can attract one interested bidder, have difficulty attracting a second bidder. This results in a poor bidding experience and a lost transaction because of the absence of a second bidder to move the bidding process along.

The disclosed online commerce platform provides technological solutions to these problems. Specifically, the disclosed online commerce platform uses novel pricing algorithms to calculate a dealer price and an estimated auction price for a given vehicle. The dealer price is a price that is set between the online commerce platform and a network of professional car buyers that the professional car buyers have agreed to pay in cash. These parameters are then used to guide the seller to create higher quality listings with fair and informed starting and reserve prices. These higher quality listings generate more interest from bidders and have higher close rates than listing created without the online commerce platform's novel algorithms. Furthermore, a novel auction software enables the online commerce platform to use the calculated dealer price as a proxy bid to iteratively increase the current bid until the current bid is above the dealer price. As a result, the novel auction software acts as a proxy bidder for the professional buyers and uses the price that the professional buyers are willing to pay to move the bidding process along. These additional elements of the novel pricing algorithms and auction software are not routine or conventional. These additional elements are technological elements that improve the online commerce platform through the creation of higher quality listings and improved bidding processes.

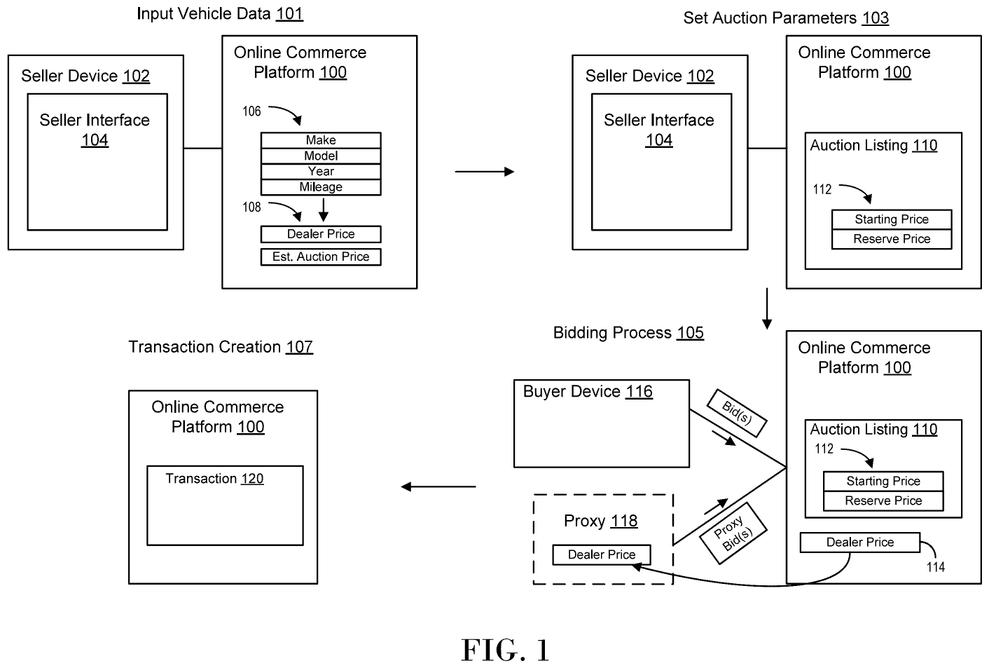

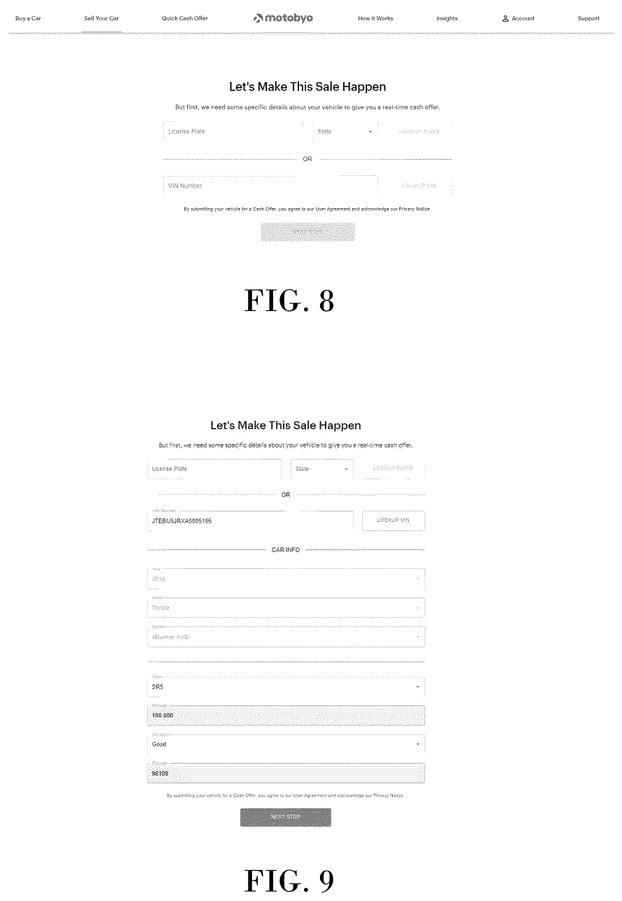

FIG. 1 illustrates a conceptual overview of different stages of the online commerce platform 100 according to some embodiments. The stages include input vehicle data 101, set auction parameters 103, bidding process 105, and transaction creation 107. In the input vehicle data 101 stage, a seller using seller device 102 may input vehicle parameters 106 via seller interface 104. An example of the seller interface 104 is shown in FIGS. 8-10. Vehicle data may include parameters such as make, model, year, mileage, trim, condition, among others. As shown, the online commerce platform 100 uses vehicle data 106 to calculate pricing data 108 of the car, which includes dealer price 108 and estimated auction price 108. The dealer price is a price that is set between the online commerce platform 100 and a network of professional buyers that the network of professional buyers has agreed in advance to pay for the cars. The estimated auction price is a price calculated by the online commerce platform predicts that a given vehicle can sell for on the online auction platform.

In set auction parameters 103 stage, the seller is asked to enter a starting price and a reserve price. The starting price is the price at which an auction starts. The reserve price is the minimum price that a seller is willing to accept from a buyer. In conventional online commerce platforms, sellers would choose the starting and reserve prices freely and without guidance or boundaries. This resulted in starting and reserve prices that were inflated and that would not attract bidders.

The disclosed online commerce platform uses the dealer price and estimated auction prices as bounds for the starting and reserve prices. Specifically, the online commerce platform 100 uses the dealer price as an upper bound for the starting price. Additionally, the online commerce platform uses the dealer price as the lower bound and the estimated auction price as the upper bound for the reserve price.

Based on observed data, starting prices that are greater than dealer prices do not attract bidders and therefore do not close. The online commerce platform 100 guides the seller to enter a starting price that has the greatest chance of attracting bidders and resulting in transactions. Additionally, reserve prices that are greater than the estimated auction price are simply low-quality listings that will not close. This is because no rational consumer will pay more for a product when they can find it for less somewhere else. The online commerce platform 100 guides the seller to enter a reserve price that is below the estimated auction price and, in this way, increases the quality of the seller's listing. Additionally, the online commerce platform 100 guides the user to enter a reserve price that is higher than the dealer price because if the professional buyers are willing to pay the dealer price for the vehicles, the seller can obtain at least that price in the auction. Once the seller selects starting and reserve prices within the acceptable bounds, online commerce platform 100 creates an auction listing 110 that has auction parameters 112 comprising the starting and reserve prices. The online commerce platform 100 can now launch the auction listing 110 to the public for bidding.

In bidding process 105 stage, a buyer using buyer device 116 is shown to place a bid on the auction listing 110. If the bid is less than the dealer price, then the online commerce platform 100 acts as proxy bidder 118 and uses the dealer price 114 as a proxy bid for the auction listing 110. A proxy bidder is a bidder than stands in place and bids on behalf of the real bidder in interest, which is the party who will pay for the goods or services sold and who will receive such goods or services in exchange. A proxy bid is the bid that the proxy bidder places on behalf of the real bidder in interest. The proxy bidder's bidding is guided by the maximum amount and the bid increments set by the real bidder in interest. Here, the online auction platform 100 serves as the proxy bidder while the real bidder in interest is the network of dealerships who have an agreement with the online auction platform 100. The online auction platform 100 uses the dealer price as the maximum bid and uses a bid increment set by the online commerce platform 100 (e.g., $100, 200, 500, etc.). If the buyer submits bid that is less than the dealer price 114, the online commerce platform 100 submits a proxy bid that is a bid increment greater than the buyer's bid. The online commerce platform 100 notifies the buyer that they've been outbid and prompts the buyer to enter a new, updated bid. This process is iterated until the buyer enters a bid that is greater than the dealer price 114. In this way, the online auction platform 100 enables the network of dealerships to be the second interested buyer to create a successful bidding process.

Assuming the buyer submitted a winning bid and that the time on the auction listing 110 has expired, the online commerce platform 100 creates a transaction 120 at the transaction creation stage 107. This involves the online commerce platform 100 closing the auction listing 110 so that it's no longer active, creating a file or entry in a database that includes the winning bid price, the item, and other parameters, and sending messages to both the buyer and the seller about the transaction that was created.

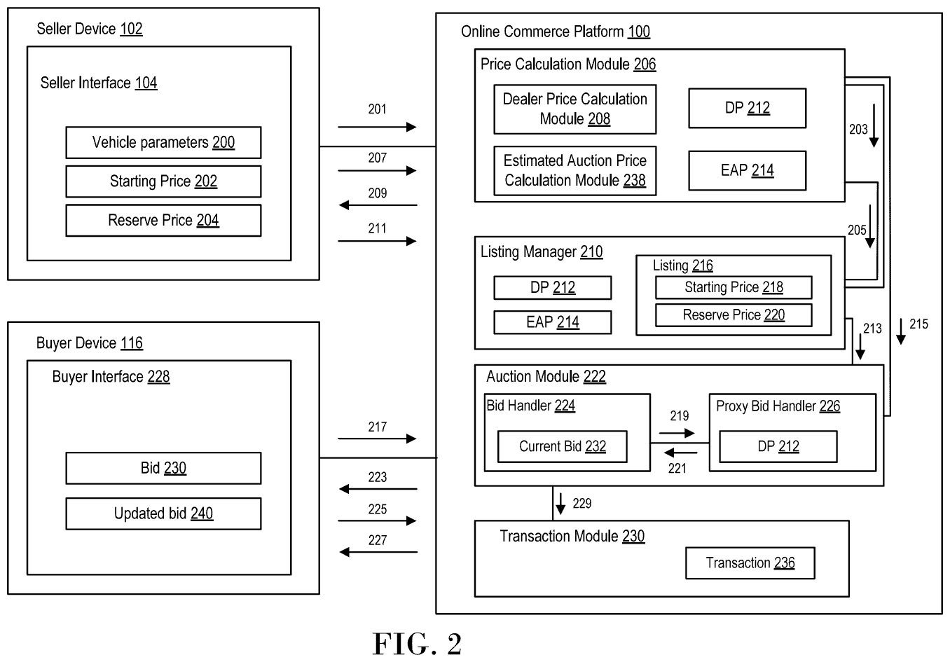

FIG. 2 shows an exemplary online commerce platform 100 performing exemplary listing creation and bidding processes, according to some embodiments. The online commerce platform 100 is shown to include a price calculation module 206, a listing manager 210, an auction module 222, and a transactions module 230. The price calculation module 206 is shown to include dealer price calculation module 208 and estimated auction price calculation module 238. The dealer price calculation modules 208 is responsible for calculating the dealer price (DP) 212, which is a wholesale price that the network of dealerships have agreed or will agree to pay for vehicles. In some embodiments, price calculation module 206 may call an application programming interface (API) to obtain the dealer price 212 instead of having the dealer price calculation module 206 calculate it. The estimated auction price calculation module 238 uses a predictive model to calculate the estimated auction price (EAP) 214 for vehicles. Specifically, the estimated auction price calculation module 238 looks at parameters associated with the vehicle that affects its price, ongoing trends in the used automobile industry, and parameters associated with buyers on the online commerce platform to predict the price that vehicles will sell for on the online commerce platform. The online commerce platform 206 uses EAP 214 in a novel way as the upper bound of the seller's reserve price. This was be discussed in detail below. In some embodiments, the online commerce platform 100 may call an API to obtain EAP 214 instead of having estimated auction price calculation module 238 calculate it.

Online commerce platform 100 is also shown to include listing manager 210, which is responsible for the creation and maintenance of auction listings. Listing manager uses DP 212 and EAP 214 as bounds for the setting of the starting price 218 and reserve price 220 of listing 216. Online commerce platform 100 is also shown to include an auction module 222 and a transaction module 230. Auction module 222 is responsible for managing auctions and is shown to include bid handler 224 and proxy bid handler 226. Bid handler 224 is responsible for receiving bids from buyer device 116 and from proxy bid handler 226 and for maintaining the current bid 232. When a new bid is received from the buyer device 116 or the proxy bid handler 226, bid handler 224 determines whether the new bid is greater than current bid 232 by a predetermined amount. If it is, bid handler 224 sets the new bid as current bid 232 and sends a notification to either buyer device 116 or auction module 222. Proxy bid handler 226 is responsible for using DP 212 as a proxy bid to iteratively increment current bid 232.

Transaction module 230 is responsible for creating transaction 236 if listing 216 has resulted a successful transaction, e.g., if the time has expired for listing 216 and current bid 232 is greater than reserve price 220. Transaction 236 may be a document, file, data entry that represents an agreement between the buyer and seller for purchase of a vehicle.

An exemplary listing creation and bidding process will now be described with reference to FIG. 2. The listing creation process starts with the seller entering vehicle parameters 200 via seller interface 104 displayed on seller device 102. As shown below, some of those vehicle parameters 200 include the make, model, mileage, and trim of the vehicle, among others. At 201, vehicle parameters 200 are sent to price calculation module 206 for calculation of DP 212 and EAP 214. Specifically, price calculation module 206 includes dealer price calculation module 208 and estimated auction price calculation module 238. Dealer price calculation module 208 is responsible for calculating a wholesale price that the network of dealerships has agreed is an acceptable price to pay a vehicle having vehicle parameters 200. Dealer price calculation module 208 calculates DP 212 for the seller's particular vehicle and price calculation module 206 sends DP 212, at 203, to listing manager 210 and, at 215, to auction module 222.

Estimated auction price calculation module 238 is responsible for predicting an actual auction price for the seller's vehicle based on vehicle parameters 200. Specifically, estimated auction price calculation module 238 processes vehicle parameters 200 to determine EAP 214. Once EAP 214 is calculated, price calculation module 206 sends EAP 214 to listing manager 210 at 205.

Next, the seller enters starting price 202 and reserve price 204 for the auction listing 216 at the seller interface 104. The starting price 202 is the minimum bid price for the auction listing when it is launched. In some embodiments, starting price 202 is defaulted to 30% of DP 212. The user may change starting price 202 freely, however. The reserve price 204 is the minimum bid for which the seller will sell the vehicle. In some embodiments, reserve price 204 is defaulted to DP 212. The user may also change reserve price 204 freely. Starting price 202 and reserve price 204 are sent, at 207, to listing manager 210.

Listing manager 210 determines if the starting price 202 is between 1 and DP 212 (or DP 202 minus 1 in some embodiments). In other words, listing manager 210 uses DP 212 as an upper bound for the starting price 202. If starting price 202 is greater than DP 202 or less than 1, listing manager will prompt the seller, at 209, to enter a starting price 202 that is less than DP 202 or that is not less than 1, respectively. In response, seller may enter an updated starting price 202 to listing manager 210 at 211. Exemplary code is shown below for processes that listing manager 210 executes:

const initialStartingPrice = Math.floor(dealerPrice * 0.3);
let initialValues = {
startingPrice: dealerPrice ? String(initialStartingPrice) :
String(startingPrice),
};
const isStartingPriceValid = (vehicleData, price) => {
const {
offerDetails: { quotePrice: dealerPrice, maxStartingPrice } =
{ },
autoDetails: { estimationType } = { },
} = vehicleData || { };
const isManualCreatedCar = estimationType ===
ESTIMATION_TYPES.
manual;
if (isManualCreatedCar) {
return isInRange(price, {
min: 1,
max: dealerPrice || maxStartingPrice,
});
}
return isInRange(price, {
min: 1,
max: dealerPrice − 1,
});
};

Listing manager 210 also determines whether reserve price 204 is between dealer price 212 and estimated auction price 214. In other words, listing manager 210 determines if the reserve price 204 is greater than the DP 212 but below the EAP 214. The reserve price should be greater than DP 212 because this is the wholesale price that a dealer is already willing to pay for the vehicle. As a result, seller need nm sell the vehicle for less than DP 212. The reserve price should be less than LAP 214 because if it is not, the vehicle likely won't sell. If reserve price is less that DP 212 or above EAP 214, listing manager 210 prompts the seller to enter a reserve price at 209 that is above DP 212 and below EAP 214, respectively. At 211, the seller enters a reserve price 204 that is above DP 212 or below LAP 214. Exemplary code for this process is shown below.

let initialValues = {
reservePrice: String(dealerPrice || reservePrice),
};
const isReservePriceValid = (vehicleData, price) => {
const {
offerDetails: { quotePrice: dealerPrice, auctionPrice,
maxStartingPrice, reservePrice } = { },
autoDetails: { estimationType } = { },
} = vehicleData;
const isManualCreatedCar = estimationType ===
ESTIMATION_TYPES.
manual;
if (isManualCreatedCar) {
return isInRange(price, {
min: dealerPrice || maxStartingPrice,
max: reservePrice,
});
}
return isInRange(price, {
min: dealerPrice,
max: auctionPrice − 1,
});
};

Next, listing manager 210 generates listing 216 is starting price 218 and reserve price 220 that are within the proper bounds and takes the listing 216 live.

Once listing 216 is live, buyers can bid on it. As shown a buyer submits bid 230 via buyer interface 228 of buyer device 116 to the online commerce platform 100. Online commerce platform 100 routes bid 230 to auction module 222. Bid handler 224 in auction module 222 determines whether bid 230 is greater than the starting price 218. Additionally, bid handler 224 determines whether bid 230 is less than DP 212. If bid handler 224 determines that current bid 232 is greater than starting price, it may set bid 230 as current bid 232. Additionally, if bid handler 224 determines that current bid 232 is less than DP 212, bid handler 224 may notify at 219 proxy bid handler 226 that current bid 232 is less than DP 212. Proxy bid handler 226 may then place a proxy bid at 221 that is greater than current bid by a predetermined about (e.g., 50, 100, 500 dollars) but less than DP 212. Bid handler 224 then sets that proxy bid as the current bid 232 and prompts the buyer, at 223, to enter another bid that is greater than the current bid 232. The buyer enters an updated bid 240 that is greater than current bid 232 but less than DP 212 at 225. Bid handler 224 may then determine that updated bid 240 is greater than current bid 232 and set the current bid 232 to updated bid 240. Bid handler 224 also determines that updated bid 240 is less than DP 212 and notifies proxy bid handler 226. Proxy bid handler 226 then places a second proxy bid that increments over current bid 232 by the predetermined amount. This process may be iterated until buyer submits another updated bid that is greater than DP 212.

Assume that buyer does submit a bid that is greater than DP 212 but less than reserve price 220 and that the time on listing 216 has expired. In that case, no transaction is created because the highest bid is still less than the reserve price 220, which is the minimum price the seller is willing accept. On the other hand, assume buyer submits a bid that is greater than DP 212 and greater than reserve price. Also assume the time on listing 216 has expired. In that case, auction module 222 notifies transaction module 230 to automatically create transaction 236 for the sale of the vehicle between the buyer and the seller. Messages are automatically sent to buyer device 102 and seller device 116 notifying them that transaction 236 has been completed.

The following code represents exemplary processes that auction module executes.

class ValidationHandler {
handle = async (bid) => {
const { proxyBid, highestProxyBid } = bid;
if (!isPositiveInt(proxyBid.amount)) throw new Error
(VALIDATION_ERRORS.auction.bid.invalidFormat);
proxyBid.amount = parseDecimal(proxyBid.amount);
const canAuctionAcceptBids = await AuctionService.
isAvailableForBidding(proxyBid);
if (!canAuctionAcceptBids) throw new Error
(VALIDATION_ERRORS.auction.bid.notAllowed);
let highestBidAmount = 0;
if (highestProxyBid) {
const highestBid = await highestProxyBid.getHighestBid( );
highestBidAmount = highestBid.amount;
}
if (proxyBid.amount <= highestBidAmount) throw new Error
(VALIDATION_ERRORS.auction.bid.lowAmount);
}
}
class ReservePriceHandler {
handle = async (bid) => {
const { proxyBid: { auction: { reservePrice, startingPrice
}, amount: amountProxy } } = bid;
let auctionReservePrice = reservePrice;
if (!reservePrice) {
auctionReservePrice = startingPrice;
}
if (auctionReservePrice >= amountProxy) {
bid.amount = amountProxy;
return;
}
const divisor = BidService.getRequiredBidDifference
(auctionReservePrice);
const rest = auctionReservePrice % divisor;
bid.amount = ((rest === 0) ? auctionReservePrice :
auctionReservePrice − rest + divisor);
}
}
class FirstBidderHandler {
handle = async (bid) => {
const { highestProxyBid } = bid;
if (!highestProxyBid) throw new BidQueueExitException( );
}
}
class OverbidSomeoneHandler {
handle = async (bid) => {
const {
proxyBid,
highestProxyBid,
proxyBid: {
user: bidder,
},
} = bid;
const highestBid = await highestProxyBid.getHighestBid( );
const isUserTheSame = (highestProxyBid.userId === bidder.
id);
if (isUserTheSame) return;
const isAmountHigher = (proxyBid.amount > highestProxyBid.
amount);
const isAmountEqual = (proxyBid.amount === highestProxyBid.
amount);
const isAmountLower = !(isAmountHigher || isAmountEqual);
const requiredBidDifference = BidService.
getRequiredBidDifference(highestBid.amount);
if (isAmountHigher) {
const amountEnoughToOutbid = highestProxyBid.amount +
requiredBidDifference;
bid.amount = Math.max(amountEnoughToOutbid, bid.amount);
const isHighestProxyReached = await ProxyBidService.
isEqualToItsHighestBid(highestProxyBid);
try {
const auction = await highestProxyBid.getAuction( );
const user = await UserRepository.findOneById
(highestProxyBid.userId);
const vehicleName = await VehicleService.
getFullVehicleName(auction);
await NotificationService.sendNotification(
[user],
USER_NOTIFICATIONS.youOutbid,
OutBidEmail,
OutbidSms,
auction,
{ },
{ vehicleName },
);
await AuctionService.sendUpdateNotification(auction,
OutbidMessage, {
customReceivers: [highestProxyBid.userId],
});
} catch (error) {
console.log(‘Message sending error: ’, error);
}
i.
j.
if (!isHighestProxyReached) {
await Bid.create({
amount: highestProxyBid.amount,
proxyId: highestProxyBid.id,
});
}
return;
}
if (isAmountEqual) {
await Bid.create({
amount: highestProxyBid.amount,
proxyId: highestProxyBid.id,
});
const message = util.format(VALIDATION_ERRORS.auction.
bid.someonesEqualProxyPresent, highestProxyBid.amount);
throw new Error(message);
}
if (isAmountLower) {
bid.amount = proxyBid.amount;
await Bid.create({
amount: proxyBid.amount + requiredBidDifference,
proxyId: highestProxyBid.id,
});
}
}
}
class OverbidSelfHandler {
handle = async (bid) => {
const {
proxyBid,
highestProxyBid,
proxyBid: {
user: bidder,
},
} = bid;
const isUserTheSame = (highestProxyBid.userId === bidder.
id);
const isAmountHigher = (proxyBid.amount > highestProxyBid.
amount);
if (!isUserTheSame) return;
if (!isAmountHigher) throw new Error (VALIDATION_ERRORS.
auction.bid.yourHigherProxyPresent);
if (bid.amount > highestProxyBid.amount) {
return;
}
highestProxyBid.amount = proxyBid.amount;
bid.proxyBid = highestProxyBid;
const highestBid = await highestProxyBid.getHighestBid( );
bid.isNewRecord = false;
bid.id = highestBid.id;
bid.amount = highestBid.amount;
}
}

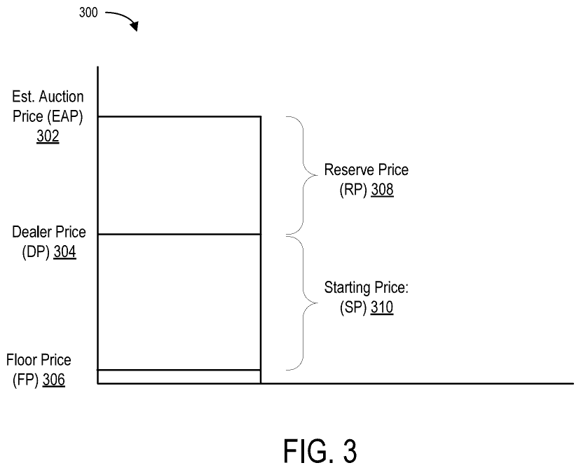

FIG. 3 shows a graph with the reserve price and starting price and their relationship with estimated auction price and dealer price, according to some embodiments. As shown, starting price (SP) 310 must be between floor price (FP) 306 (e.g., $1) and dealer price (DP) 304, while reserve price (RP) 308 must be between DP 304 and estimated auction price (EAP) 302.

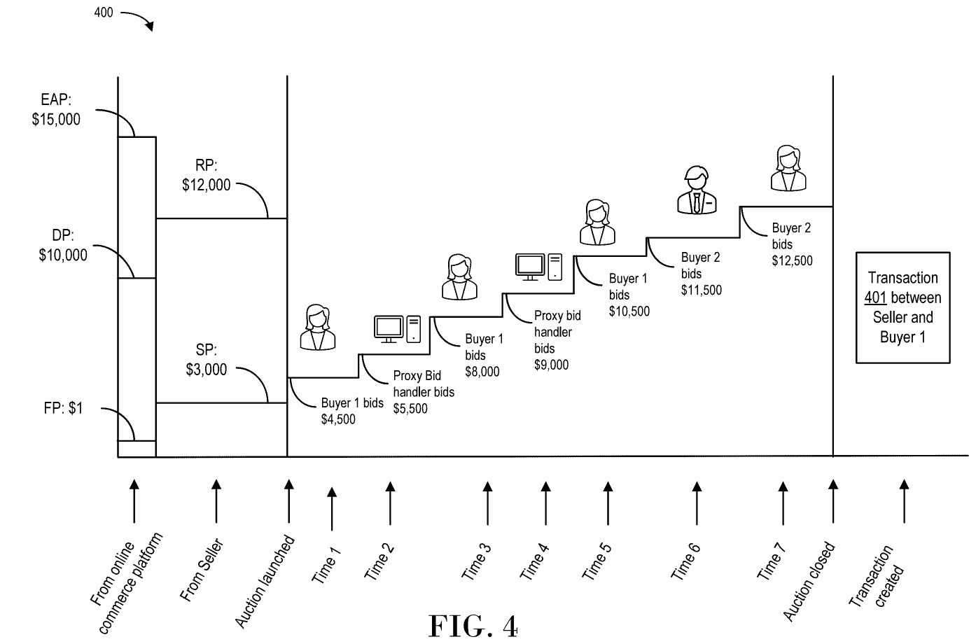

FIG. 4 shows an exemplary bidding process 400 involving the proxy bidding handler according to some embodiments. As shown, the floor price is $1, the dealer price is $10,000 and estimated auction price is $15,000. The seller in this example, the seller has selected a starting price of $3,000 and a reserve price of $12,000.

As shown, buyer 1 bids $4,500 at time 1. Since this amount is less than the dealer price, proxy bid handler submits a bid that is a predetermined amount above the next highest bid. Here, proxy bid handler bids $5,500 at time 2. At time 3, buyer submits a bid of $8,000 and at time 4, proxy bid handler submits a bid of $9,000. After than buyer 1 submits a bid of $10,500, which is greater than dealer price but less than the reserve price. Since the bid of $10,500 is greater than the dealer price, proxy bid handler will no longer be placing bids on the vehicle. Buyer 2 places a bid of $11,500 at time 6 and buyer 1 places a bid of $12,500 at time 7. Buyer 1's bid of $12,500 is the highest bid at the time of expiration and so buyer 1 wins the auction. In response, a transaction 401 between seller and buyer 1 is created.

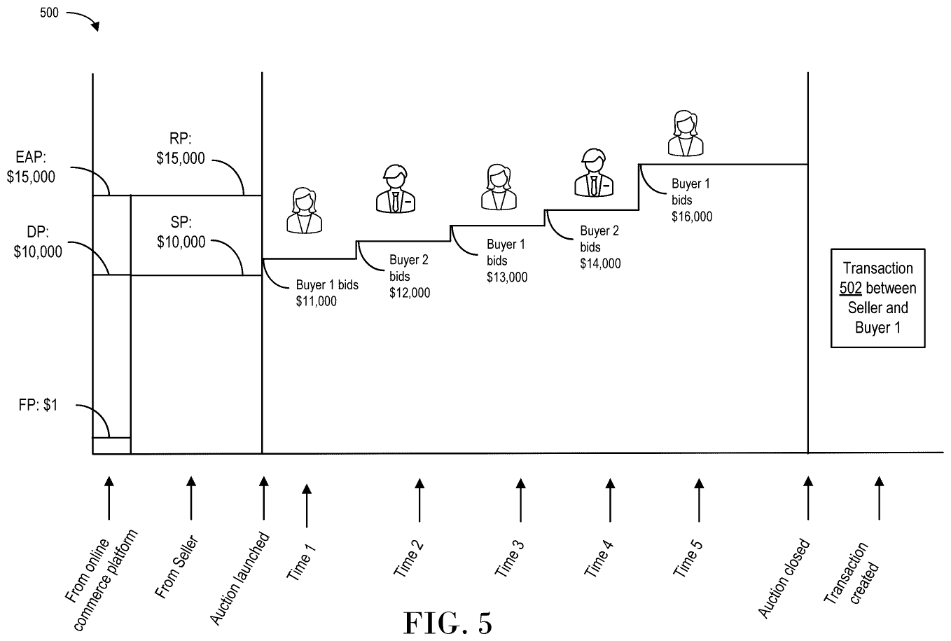

FIG. 5 shows an exemplary bidding process 500 according to some embodiments. In the process shown, the floor price, dealer price, and estimated auction price are the same as they were in FIG. 4. What is different is the starting price, which is set at $10,000 and the reserve price, which is set at $15,000. In this example, buyer 1 bids $11,000 at time 1. Since the first bid is greater than the dealer price of $10,000, the proxy bid handler has nothing to do; it only places proxy bids when the current bid is less than the dealer price. As shown, buyer 2 and buyer 1 place sequentially greater bids until buyer 1 places the highest bid of $16,000 at time 5. Since this bid is the greatest bid at the time the auction is closed and because it is greater than the reserve price of $14,000, a transaction is created between seller and buyer 1.

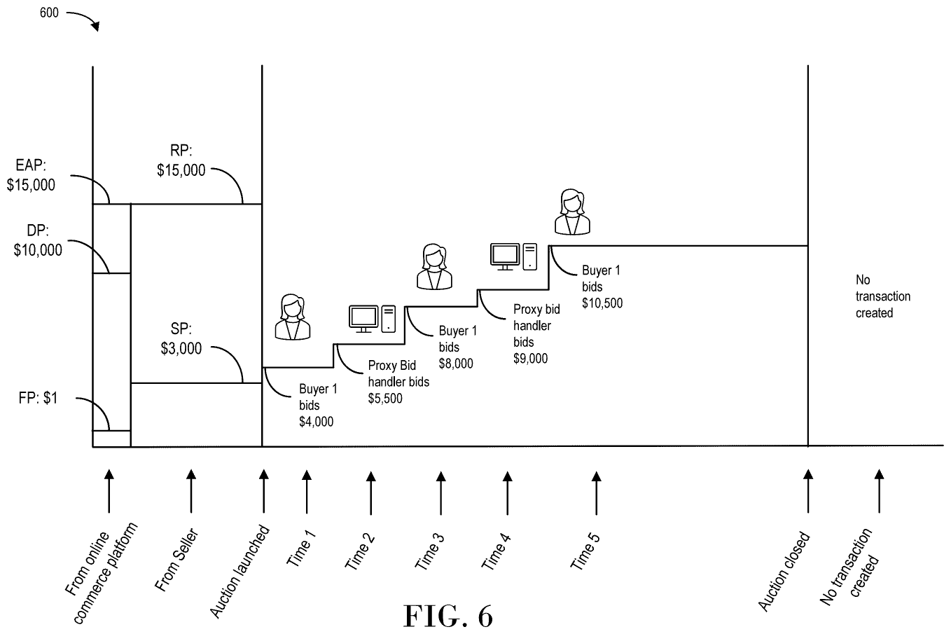

FIG. 6 shows another exemplary bidding process 600 according to some embodiments. In this example, the floor price, dealer price, and estimated auction price are the same as they were in FIGS. 4 and 5. The starting price is set is $3,000 and the reserve price is set to $15,000, the same as the estimated auction price. As shown, buyer 1 bids $4,000 at time 1 and proxy bid handler bids $5,500 as time 2. Next, buyer 1 bids $8,000 at time 3 and proxy bid handler bids $9,000 at time 4. Buyer 1 then bids $10,500 at time 5. Because this bid is higher than the dealer price of $10,000, the proxy bid handler does not continue to place bids. Further, a second buyer is does not place any bids on this auction listing. As a result, buyer 1's remains the highest bid at auction closing and the auction does not result in a transaction.

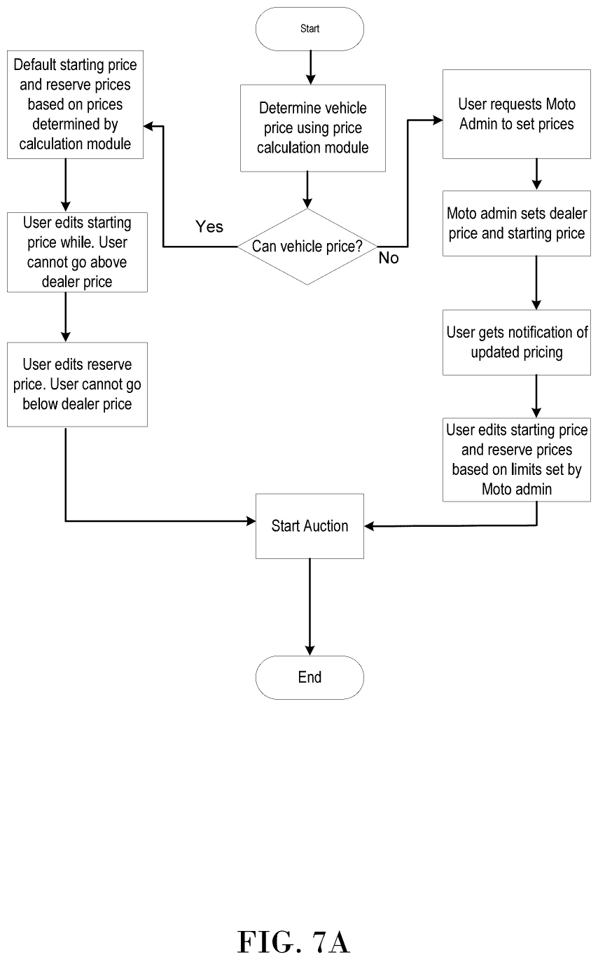

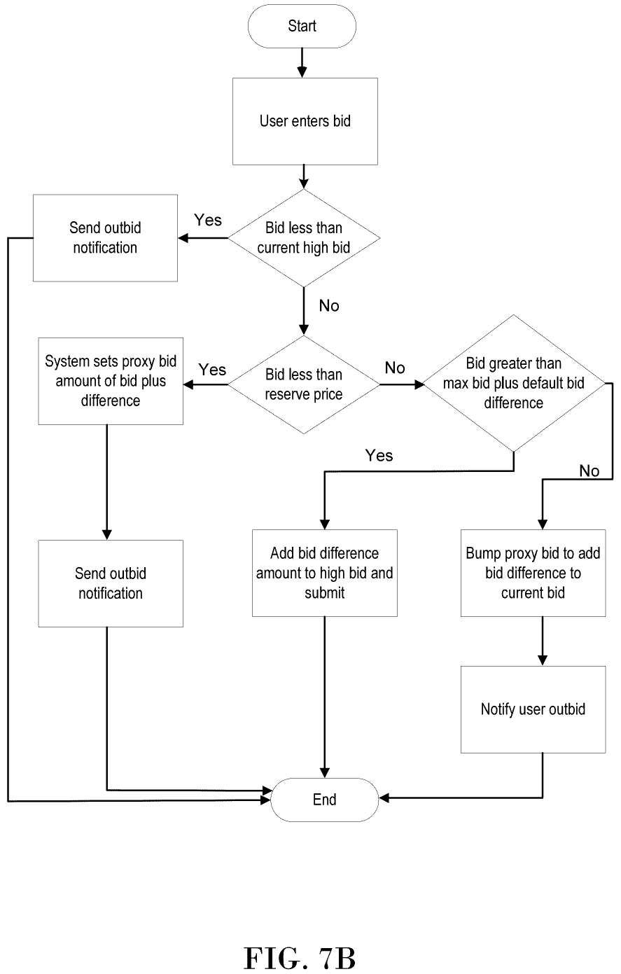

FIG. 7A shows a flow chart of an exemplary listing creation process, according to some embodiments. After the process starts the vehicle price is determined by using the price calculation module. If the vehicle can be priced by the vehicle calculation module, the process then defaults the starting price and reserve prices based on prices determined by the price calculation module. Next, the user edits the starting price with the process making sure that the edited starting price does not go above the dealer price. The user may then edit the reserve price with the process ensuring that the user does not go below the dealer price. Then the auction is started. On the other side of the flow chart, if the vehicle cannot be priced, the user requests an administrator to set the reserve and starting prices and the administrator obliges. The user gets a notification of the updated pricing, and the user edits the starting prices and reserve prices based on limits set by an administrator. Then the auction is started.

FIG. 7B shows a flow chart of an exemplary bidding process, according to some embodiments. The user begins by entering a bid and the online commerce platform compares whether the entered bid is less than the current bid. If it is, the user is sent an outbid notification and the process ends. If not, the online commerce platform determines if the entered bid is less than the reserve price. If it is, the system sets a proxy bid amount of the bid plus a difference and then sends and outbid notification. If the entered bid is not less than the reserve price, the online commerce platform determines if the bid is greater than the max bid plus default bid difference. If it is, the online commerce platform adds bid difference amount to high bid and submits the bid. If it is not, the online commerce platform bumps the proxy bid to add bid difference to current bid and notifies the user that it has been outbid.

FIG. 8 shows a seller interface for inputting vehicle parameters of the online commerce platform according to some embodiments. In the interface shown, the seller may input their license plate number and the state in which their vehicle is registered. Alternatively, the seller may input their VIN number.

FIG. 9 shows the seller interface for inputting additional vehicle parameters, according to some embodiments. As shown, the seller can input the year, make, model, style, mileage, condition, and zip code associated with their car.

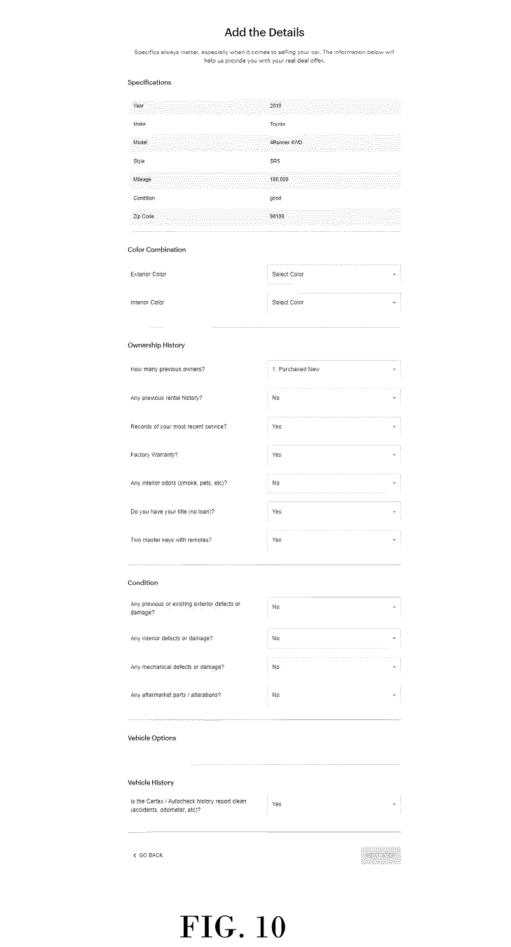

FIG. 10 shows the seller interface for inputting additional vehicle parameters, according to some embodiments. As shown, the seller may input exterior color, interior color, and other information about ownership, condition, and vehicle history using the illustrated interface.

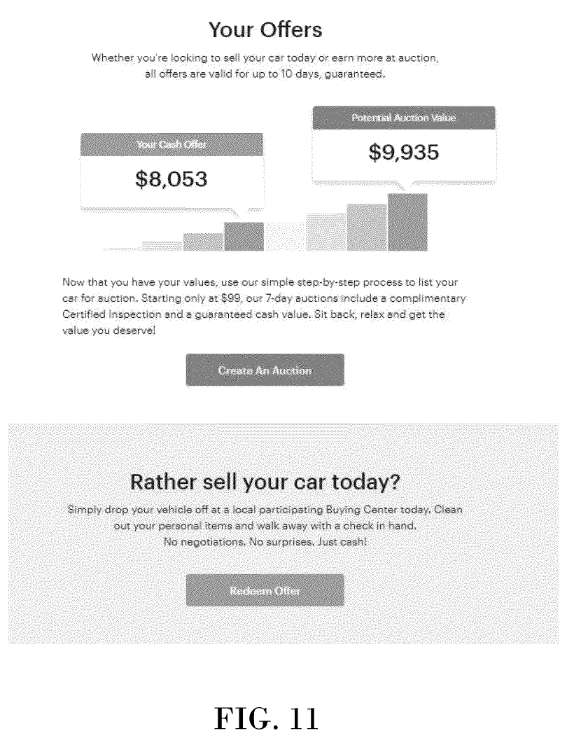

FIG. 11 shows the online commerce platform displaying the dealer price (e.g., “cash offer”) and the estimated auction price (e.g., “potential auction value”) for an example car, according to some embodiments. For example, the dealer price here is shown to be $8,053 while the estimated auction value is shown to be $9,935. If the seller wishes to sell the vehicle right away and without going through the auction process, they may choose to sell the vehicle for $8,053. The online commerce platform will then arrange for the sale of the vehicle to a dealer or other buyer within the network of professional buyers. On the other hand, if the seller wishes to make more than $8,053, they may continue with creating an auction for the vehicle.

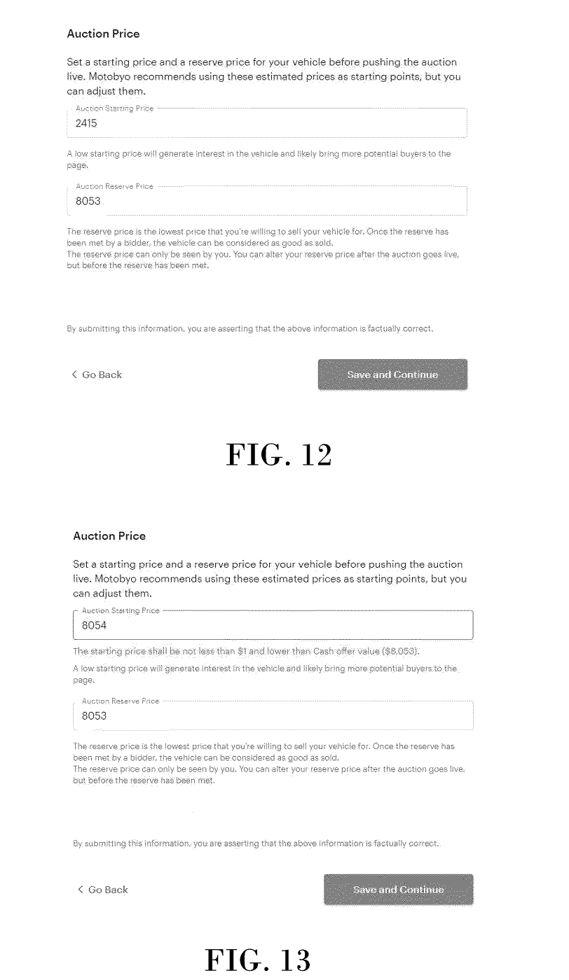

FIG. 12 shows a user inputting a starting price and a reserve price for a vehicle, according to some embodiments. As shown, the interface includes a field for the starting price of the auction, which by default is set to 30% of the dealer price (e.g., 0.3*8053). The interface also includes a field for the reserve price, which by default is set to the dealer price (e.g., $8053).

FIG. 13 shows the online commerce platform prompting the user to enter a starting price that is lower than the dealer price, according to some embodiments. As shown, the seller has entered a starting price of $8,054, which is a dollar more than the dealer price of $8,053. In response, the online commerce platform prompts “The starting price shall not be less than $1 and lower than Cash offer value ($8,053).”

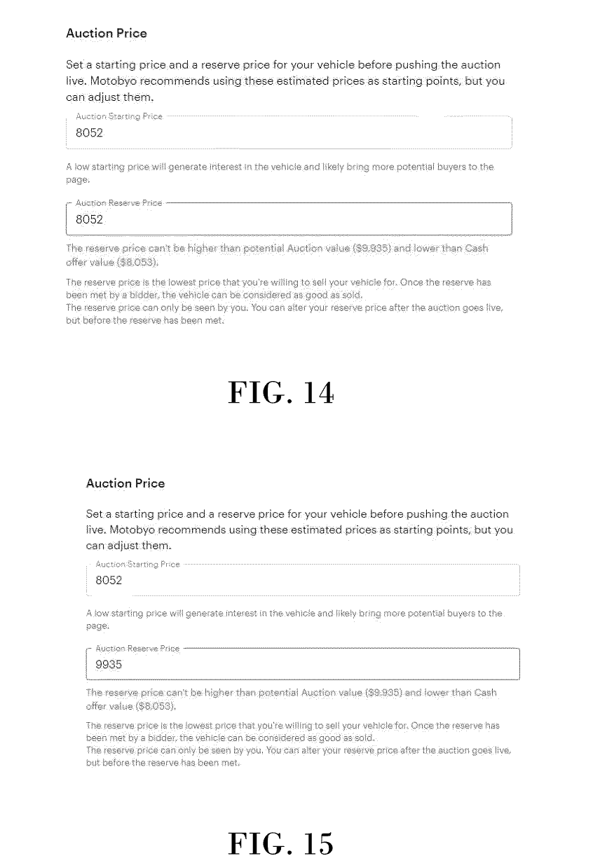

FIG. 14 shows the online commerce platform prompting the user to enter a reserve price that is greater than the dealer price, according to some embodiments. As shown, the seller has entered $8,052 for the reserve price, which is lower than the dealer price of $8,053. In response, the online commerce platform prompts the seller “The reserve price can't be higher than potential auction value ($9,935) and lower than Cash offer value ($8,053).”

FIG. 15 shows the online commerce platform prompting the user to enter a reserve price that is less than estimated auction price, according to some embodiments. As shown, the seller has entered $9,935 for the reserve price. In response, the online commerce platform prompts the seller “The reserve price can't be higher than potential auction value ($9,935) and lower than Cash offer value ($8,053).”

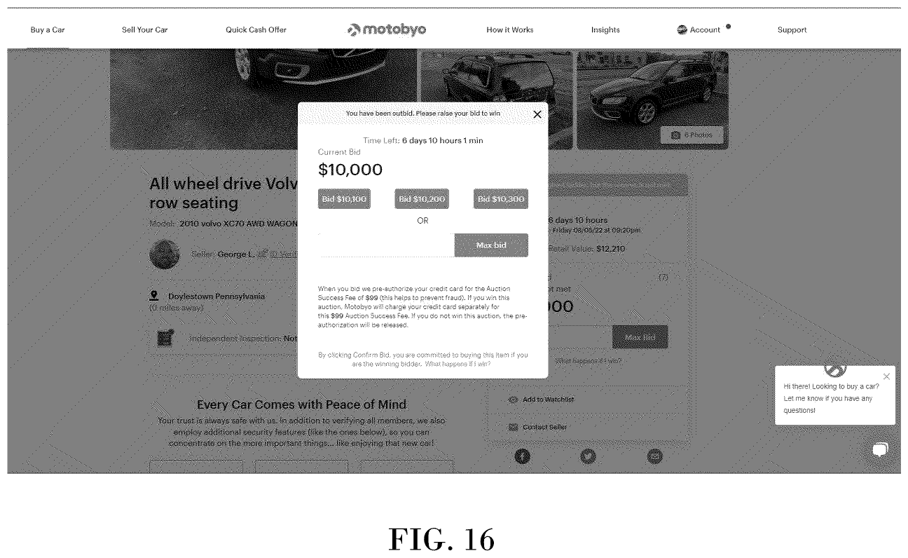

FIG. 16 shows the online commerce platform prompting a buyer to enter an updated bid in response to being outbid by the proxy bid handler, according to some embodiments. As shown, proxy bid handler has outbid the current bid of $10,000. Now, the online commerce platform prompts the buyer to submit an updated bid of one of $10,100, $10,200, or $10,300.

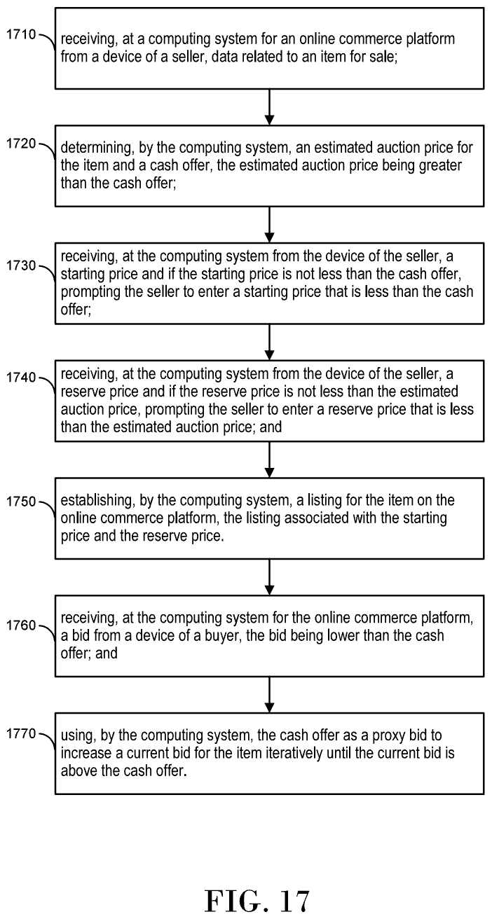

FIG. 17 shows an overall flow of a method performed by the online commerce platform, according to some embodiments. The method includes receiving, at a computing system for an online commerce platform from a device of a seller, data related to an item for sale. The method also includes determining, by the computing system, an estimated auction price for the item and a cash offer, the estimated auction price being greater than the cash offer. The method then provides receiving, at the computing system from the device of the seller, a starting price and if the starting price is not less than the cash offer, prompting the seller to enter a starting price that is less than the cash offer. Additionally, the method provides receiving, at the computing system from the device of the seller, a reserve price and if the reserve price is not less than the estimated auction price, prompting the seller to enter a reserve price that is less than the estimated auction price. The method further provides establishing, by the computing system, a listing for the item on the online commerce platform, the listing associated with the starting price and the reserve price. Moreover, the method provides receiving, at the computing system for the online commerce platform, a bid from a device of a buyer, the bid being lower than the cash offer. The method then provides using, by the computing system, the cash offer as a proxy bid to increase a current bid for the item iteratively until the current bid is above the cash offer.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A method, comprising:
receiving, at a computing system for an online commerce platform from a device of a seller, data related to an item for sale;
determining, by the computing system, an estimated auction price for the item and a dealer price, the estimated auction price being greater than the dealer price;
receiving, at the computing system from the device of the seller, a starting price and if the starting price is not less than the dealer price, prompting the seller to enter a starting price that is less than the dealer price;
receiving, at the computing system from the device of the seller, a reserve price and if the reserve price is not less than the estimated auction price, prompting the seller to enter a reserve price that is less than the estimated auction price; and
establishing, by the computing system, a listing for the item on the online commerce platform, the listing associated with the starting price and the reserve price.

2. The method of claim 1, further comprising:
receiving, at the computing system for the online commerce platform, a bid from a device of a buyer, the bid being lower than the dealer price; and
using, by the computing system, the dealer price as a proxy bid to increase a current bid for the item iteratively until the current bid is above the dealer price.

3. The method of claim 2, further comprising:
determining, by the computing system, if the current bid is also above the reserve price;
if the current bid is above the reserve price, (time expires) closing the listing and automatically create a transaction between the buyer and the seller for the sale of the item; and
if the current bid is above the dealer price but below the reserve price, keeping the listing open until the current bid is above the reserve price (or until the time expires).

4. The method of claim 2, wherein increasing the current bid for the item iteratively includes:
incrementing the current bid by a predetermined amount over the bid from the buyer;
receiving an updated bid from the device of the buyer;
repeating said incrementing and said receiving until the current bid is above the dealer price.

5. The method of claim 1, wherein said determining the dealer price for the item includes:
sending at least a portion of the data related to the item to a dealer price calculation module; and
receiving the dealer price from the dealer price calculation module.

6. The method of claim 1, wherein said determining the estimated auction price comprises:
using an estimated auction price calculation module to predict the estimated auction price of the item based on the data related to the item.

7. The method of claim 1, further comprising:
sending, by the computing device to the device of the buyer, a GUI for inputting the starting price and the reserve price, wherein the starting price defaults to a fraction of the dealer price and the reserve price defaults to the dealer price.

8. The method of claim 1, wherein the item is an automobile.

9. A non-transitory machine-readable medium storing a program executable by at least one processing unit of a device, the program comprising sets of instructions for:
receiving, at a computing system for an online commerce platform from a device of a seller, data related to an item for sale;
determining, by the computing system, an estimated auction price for the item and a dealer price, the estimated auction price being greater than the dealer price;
receiving, at the computing system from the device of the seller, a starting price and if the starting price is not less than the dealer price, prompting the seller to enter a starting price that is less than the dealer price;
receiving, at the computing system from the device of the seller, a reserve price and if the reserve price is not less than the estimated auction price, prompting the seller to enter a reserve price that is less than the estimated auction price; and
establishing, by the computing system, a listing for the item on the online commerce platform, the listing associated with the starting price and the reserve price.

10. The non-transitory machine-readable medium of claim 9, further comprising:
receiving, at the computing system for the online commerce platform, a bid from a device of a buyer, the bid being lower than the dealer price; and
using, by the computing system, the dealer price as a proxy bid to increase a current bid for the item iteratively until the current bid is above the dealer price.

11. The non-transitory machine-readable medium of claim 10, further comprising:
determining, by the computing system, if the current bid is also above the reserve price;
if the current bid is above the reserve price, (time expires) closing the listing and automatically create a transaction between the buyer and the seller for the sale of the item; and
if the current bid is above the dealer price but below the reserve price, keeping the listing open until the current bid is above the reserve price (or until the time expires).

12. The non-transitory machine-readable medium of claim 10, wherein increasing the current bid for the item iteratively includes:
incrementing the current bid by a predetermined amount over the bid from the buyer;
receiving an updated bid from the device of the buyer;
repeating said incrementing and said receiving until the current bid is above the dealer price.

13. The non-transitory machine-readable medium of claim 9, wherein said determining the dealer price for the item includes:
sending at least a portion of the data related to the item to a dealer price calculation module; and
receiving the dealer price from the dealer price calculation module.

14. The non-transitory machine-readable medium of claim 9, wherein said determining the estimated auction price comprises:
using an estimated auction price calculation module to predict the estimated auction price of the item based on the data related to the item.

15. The non-transitory machine-readable medium of claim 9, further comprising:
sending, by the computing device to the device of the buyer, a GUI for inputting the starting price and the reserve price, wherein the starting price defaults to a fraction of the dealer price and the reserve price defaults to the dealer price.

16. The non-transitory machine-readable medium of claim 9, wherein the item is an automobile.

17. A system comprising:
a set of processing units; and
a non-transitory machine-readable medium storing instructions that when executed by at least one processing unit in the set of processing units cause the at least one processing unit to:
receive, at a computing system for an online commerce platform from a device of a seller, data related to an item for sale;
determine, by the computing system, an estimated auction price for the item and a cash offer, the estimated auction price being greater than the cash offer;
receive, at the computing system from the device of the seller, a starting price and if the starting price is not less than the cash offer, prompting the seller to enter a starting price that is less than the cash offer;
receive, at the computing system from the device of the seller, a reserve price and if the reserve price is not less than the estimated auction price, prompting the seller to enter a reserve price that is less than the estimated auction price; and
establish, by the computing system, a listing for the item on the online commerce platform, the listing associated with the starting price and the reserve price.

18. The system of claim 17, wherein the instructions further cause the at least one processing unit to:
receiving, at the computing system for the online commerce platform, a bid from a device of a buyer, the bid being lower than the cash offer; and
using, by the computing system, the cash offer as a proxy bid to increase a current bid for the item iteratively until the current bid is above the cash offer.

19. The system of claim 18, wherein the instructions further cause the at least one processing unit to:
determining, by the computing system, if the current bid is also above the reserve price;
if the current bid is above the reserve price, (time expires) closing the listing and automatically create a transaction between the buyer and the seller for the sale of the item; and
if the current bid is above the cash offer but below the reserve price, keeping the listing open until the current bid is above the reserve price (or until the time expires).

20. The system of claim 18, wherein the instructions further cause the at least one processing unit to:
incrementing the current bid by a predetermined amount over the bid from the buyer;
receiving an updated bid from the device of the buyer;
repeating said incrementing and said receiving until the current bid is above the cash offer.
